(19) United States
(12) Patent Application Publication
(10) Pub. No.: US 2003/0007889 A1
(43) Pub. Date: Jan. 9, 2003

(54) Multi-burner flame ionization combustion chamber

(76) Inventors: Po Chien, Rancho Pales Verdes, CA (US); Stephen Stephanos, Long Beach, CA (US)

Correspondence Address: John E. Vanderburgh, 608 Sunset Road, Louisville, KY, 40206, US

(21) Appl. No.: 09/864,886

(22) Filed: May 24, 2001

(51) Int. Cl. G01N 25/20

(52) U.S. Cl. 422/54

(57) ABSTRACT

A combustion cell for flame ionization detectors consists of a housing having an interior defining a combustion chamber that is in communication with a source of an oxygen containing gas. Two or more burner nozzles are located in the combustion chamber and each of the burner nozzles communicate with a common source of a sample gas. One or more collectors are disposed in the for the sensing of a electrical current created by the combustion and ionization of a sought for substance. In operation two or more burner nozzles are used for combustion of the sample/fuel mixture to enhance the sensitivity and linearity of the output signal.

### FIELD OF THE INVENTION

This invention relates to flame ionization and more particularly to an improved burner assembly for flame ionization detection apparatus.

### BACKGROUND OF THE INVENTION

Flame ionization detectors are the most commonly used type of detectors for gas chromatography and for air purity measuring devices, such as devices for measuring auto emissions and the like. Conventionally these detectors utilize a mixture of a fuel, such as hydrogen, and the sample gas being tested and ignite the mixture in the presence of polarized electrodes. Ignition of the sample gas causes the molecule being detected to become ionized whereupon the electrons are collected on the negative electrode, commonly referred to as the collector. The migration of ions and electrons creates a small ionic current between the electrodes which is related to the quantity of sought for material in the combustion mixture. Accordingly, as the quantity or the composition of the sample gas changes, a variation in the ionic current can be detected and correlated with the chemical changes.

The sensitivity of the flame ionization detector is dependent, among other factors, on the amount of sample flowing into the burner assembly of the apparatus. Inconsistencies in the flow of the fuel and sample gas can mask the small ionic current or, at the least, producer errors in the readout of the ionic current.

Prior art flame ionization detectors cells conventionally have a single burner through which the sample and the fuel are passed. In order to achieve the sensitivities desired a sufficient amount of sample must flow to the burner for combustion. In order to detect small quantities of the sought for molecule in the sample it is necessary to maintain a relatively high flow rate of the sample to the burner. This also requires additional flow of fuel as well in order to achieve proper combustion. The increased flow rate of sample and fuel produces a relatively large flame which increases the background signal noise which in many cases can mask the signal from the ionization of the sought for molecule. In addition, the flame produced may be larger than the collection area of the collector so that ionization of some of the molecules does not produce a measurable current.

### SUMMARY OF THE INVENTION

Accordingly, it is an object of the present invention to provide an improved combustion cell for flame ionization detectors.

It is another object to provide a combustion cell which permits the detection of lower limits of sought for substances while producing lower background signal.

It tet another object of the invention to provide a combustion cell for flame ionization detectors that is stable and exhibits little drift over time.

The objects and advantages of the invention are achieved by a combustion cell that includes multiple burners. Increasing the number of burners substantially increases the signal output and, in addition, produces a cleaner signal and a smaller flame. The combustion cell operates with a flame size which allows for lamellar flow of the sample gas and fuel to the burners to produce a smoother burn that reduces signal noise. The overall improvement in performance of the combustion cell of the invention is demonstrated by a substantial improvement in instrument sensitivity and lowered detection limits of instruments employing the multi-burner cell of the invention.

### DESCRIPTION OF THE DRAWINGS

FIG. 1 is a sectional view of a combustion cell designed in accordance with the present invention and that contains two burners.

FIG. 2 is a schematic plan view of a three burner combustion cell.

FIG. 3 is a schematic plan view of a nine burner combustion cell.

FIG. 4 is a schematic plan view of a twelve burner combustion cell having collection plates running in both the horizontal and vertical direction

### DETAILED DESCRIPTION OF THE INVENTION

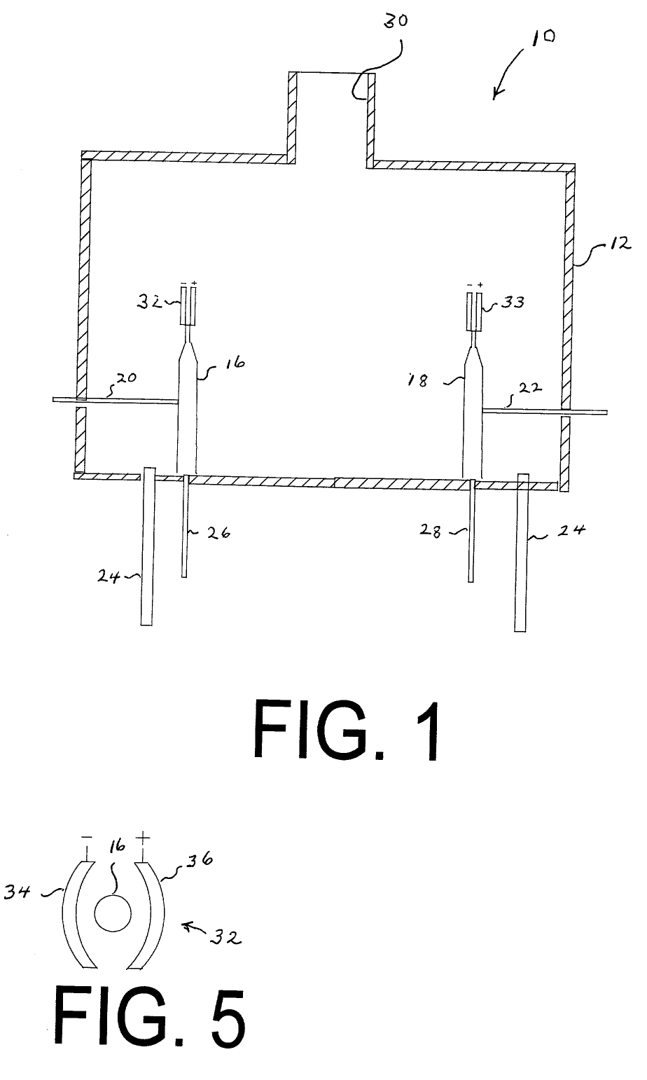

FIG. 1 illustrates in simplified form a two burner combustion cell 10 in accordance with the present invention. The combustion cell 10 comprises a housing 12 having an interior that defines a combustion chamber 14. Burner nozzles 16 and 18 are disposed in the combustion chamber 14 and sample gas is led into the nozzles by capillaries 20 and 22 that communicate with a manifold (not shown) for distribution of the sample gas to the burner nozzles 16 and 18. A line 24 communicates with the combustion chamber 14 and a source of air or oxygen for the introduction of oxygen into the combustion chamber to support combustion. Lines 26 and 28 communicate with the burner nozzles 16 and 18 respectively and with a source of fuel, such as hydrogen. The top wall of the housing 12 opens to exhaust at 30 for leading combustion products out of the combustion chamber 14.

The amount of sought for substance in the sample gas is directly related to the strength of the current produced by the ionization of the sought for substance during combustion of the sample gas. This current is detected by one or more collectors disposed in the combustion chamber 14 adjacent the burner nozzles 16 and 18. As is conventional, each of the collectors consists of a pair of polarized electrodes and the current is collected at the negative electrode and passed to suitable current amplification and current read out devices. In the embodiment illustrated the collectors consist of cylindrical electrodes 32 that surround the tips of the burner nozzles 16 and 18 respectively. In this embodiment the burner nozzles 16 and 18 serve as the positive electrode of the collector. The cylindrical electrodes 32 are connected to a source of power by a line 34 and a line 36 connects the burner nozzles 16 and 18 to the electrical circuit for imposing a potential on the burner nozzles and the cylindrical electrodes to polarize the cylindrical electrodes with respect to the burner nozzles. The lines 34 and 36 conduct the current created by the flow of ions to the cylindrical electrode 32 during combustion of the sample and they are connected to a current amplifier and an ammeter (not shown), both of conventional design for amplification and read out of the ionization current. It will be clear that the cylindrical electrodes 32 and the burner nozzles 16 and 18 are formed from a conductive yet sufficiently heat resistant material, such as for example, stainless steel to withstand the combustion conditions in the combustion chamber 14.

An ignition device (not shown), such as a glow plug or spark igniter, is provided in the wall of the combustion chamber 14 adjacent the burner nozzles 16 and 18 for ignition of the sample/fuel/air mixture. Depending on the size of the combustion chamber 14 and the number of burners, more than one ignition device may be employed in the combustion chamber 14.

In operation, fuel is led into the burner nozzles 16 and 18 through the lines 26 and 28 respectively and air is introduced into the combustion chamber 14 through the line 24. Sample gas enters the burner nozzles 16 and 18 by the capillaries 20 and 22. Flow rates for the sample gas and the fuel will range between—and—Combustion is initiated in the conventional manner by the ignition device. Combustion ionizes the molecules of the sought for substance in the sample gas which creates an ionization current that is detected by the negative electrode 32 of the collector. The use of the dual burner nozzles 16 and 18 reduces the amount of sample gas and fuel to a single burner nozzle. This results in the production of a smaller flame which is substantially the same size as or slightly smaller than the negative electrode 32 of the collector. In this manner substantially all of the current produced by the ionized molecules of the sought for substance is “seen” by the collector since the smaller flame ionizes the molecule of sought for substance within the sensing face of the negative electrode 32. Thus loss of signal as the result of ionization of molecules in portions of the flame extending beyond the sensing area of the collector electrodes, as is often the case with a conventional single burner combustion cell, is substantially reduced. In addition doubling the combustion stones with the resultant increases of the ionization current produced and collected substantially increases sensitivity of the flame ionization detector utilizing the duel burner nozzles 16 and 18 in the combustion cell 10.

### EXAMPLE

A combustion chamber 14 containing two burner nozzles 16 and 18 as illustrated in FIG. 1 and described above was tested for noise, drift and linearity. The noise and drift tests were conducted over a 14 hour period utilizing 200 ppb methane in nitrogen span gas. The fuel gas was 60/40 Helium/Hydrogen. In addition, noise levels were checked using nitrogen zero gas. The span gas was introduced to the burner nozzles at a flow rate of—cfm and the fuel at a flow rate of—cfm. For the drift test the ambient temperature change was slightly greater than 10 degrees centigrade. The results are set forth below.

| Noise Level | |
|---|---|
| Span Gas | ˜1 ppb (˜0.5%) |
| Zero Gas | ˜1 ppb (˜0.5%) |
| Instrument Drift (over 14 hour period/>10° C. Δ | |
| ambient temp. | |
| Span Gas | ˜5 ppb (˜2.5%) |

Linearity tests were conducted using 60/40 Helium/Hydrogen fuel. The sought for substance was methane in nitrogen sample gas. Linearity tests were conducted with two sample gases containing methane in concentrations ranging from 0 to 10 ppm and from 0 to 1 ppm. The results are reported in Table 1 and Table 2 respectively.

TABLE 1
(0-10 ppm)

| Input, CH₄ ppm | Measured, ppm | % off as Span | % off as point |
|---|---|---|---|
| 0.000 | 0.000 | 0.00 | 0.00 |
| 1.000 | 1.018 | 0.18 | 1.76 |
| 2.000 | 2.003 | 0.03 | 0.15 |
| 3.000 | 2.992 | −0.08 | −0.28 |
| 4.000 | 3.983 | −0.17 | −0.43 |
| 5.000 | 4.980 | −0.20 | −0.39 |
| 6.000 | 5.977 | −0.23 | −0.38 |
| 7.000 | 6.976 | −0.24 | −0.34 |
| 8.000 | 7.979 | −0.21 | −0.27 |
| 9.000 | 8.995 | −0.05 | −0.06 |
| 10.000 | 10.000 | 0.00 | 0.00 |

TABLE 2
(0-1 ppm)

| Input, CH₄ ppm | Measured, ppm | % off as Span | % off as point |
|---|---|---|---|
| 0.000 | 0.000 | 0.00 | 0.00 |
| 0.100 | 0.101 | 0.12 | 1.21 |
| 0.200 | 0.199 | −0.06 | −0.31 |
| 0.300 | 0.298 | −0.19 | −0.62 |
| 0.400 | 0.397 | −0.33 | −0.82 |
| 0.500 | 0.497 | −0.30 | −0.60 |
| 0.600 | 0.597 | −0.31 | −0.52 |
| 0.700 | 0.697 | −0.26 | −0.37 |
| 0.800 | 0.798 | −0.23 | −0.29 |
| 0.900 | 0.900 | −0.04 | −0.04 |
| 1.000 | 1.000 | 0.00 | 0.00 |

As can be seen from the results of the foregoing, linearity at low level concentrations of sought for substance is excellent and exceeds current standards for most conventional flame ionization detectors. In addition, it can be seen that the cell is stable and exhibits substantially no drift over the 14 hour period. The linearity at low concentrations of sought for substance demonstrates the improved sensitivity of the multi-burner combustion cell. Thus, while conventional single burner combustion cell have a lower detection limit of on the order of 1000 ppb, the dual burner cell of the example demonstrates a lower detection limit of on the order of 200 ppb.

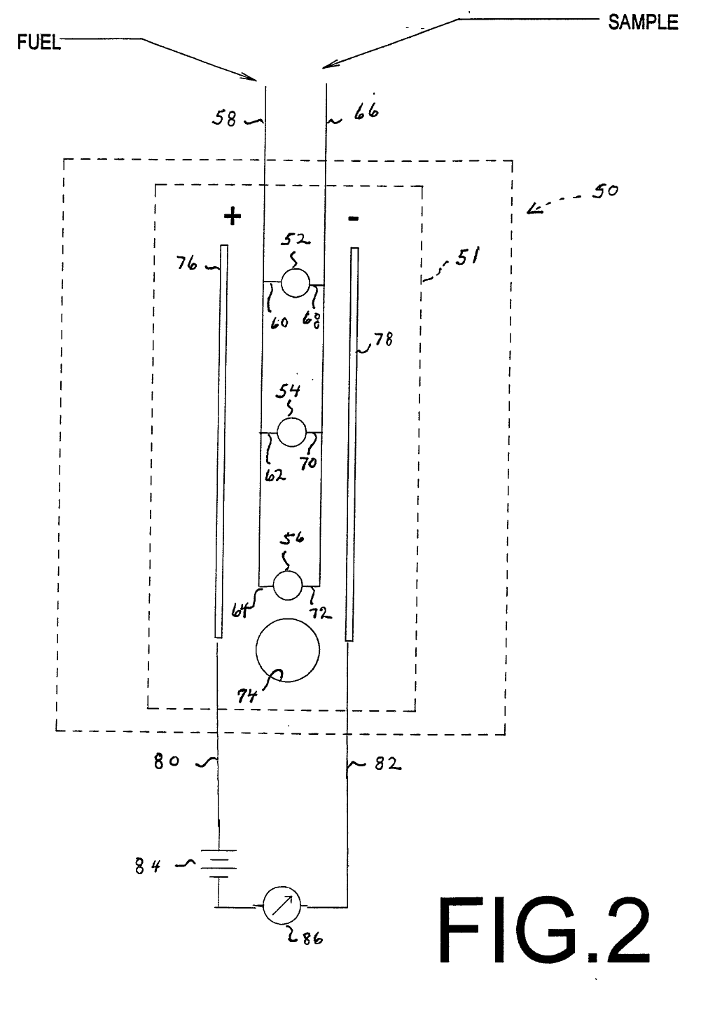

While the invention has thus far been described in connection with a duel burner combustion cell, more than two burner nozzles may be employed with good results. Referring to FIG. 2, a three burner combustion cell is schematically illustrated. The combustion cell, shown generally as 50, comprises a housing 51 in which are disposed three burner nozzles 52, 54 and 56. A fuel line 58 communicates with a source of fuel (not shown) and connector lines 60, 62 and 64 communicate between the fuel line and the burner nozzles 52, 54 and 56. Similarly, a line 66 communicates with a source of the sample gas and capillaries 68, 70 and 72 communicate between the sample line 66 and the burner nozzles 52, 54 and 56. An opening 74 in the housing 51 is provided for the introduction of air or oxygen through a line (not shown). The collector consists of a pair of electrode plates 76 and 78. One electrode plate is disposed on each side of the burner nozzles 52, 54 and 56 and both of the electrode plates 76 and 78 extend at least the length of the row formed by the burner nozzles. The electrode plates are 76 and 78 are electrically connected by lines 80 and 82 to a source of power, such as a battery 84 for imposition of a potential to polarize the electrode plates. A readout device, such as an ammeter 86, and a suitable current amplification device (not shown) are connected into the circuit.

In operation the sample gas enters the housing 51 of the combustion cell 50 by the line 66. The line 66 and the capillaries 68, 70 and 72 combine to form a manifold for distributing the sample gas to the burner nozzles 52, 54 and 56. Similarly the fuel is introduced to the burner nozzles 52, 54 and 56 through the line 58 and connector lines 60, 62 and 64. A potential is imposed creating the positive collector plate 78 and the negative collector plate 76. Combustion of the sample gas ionizes the sought for substance and creates an ionization current through the collector that flows through the line 80 for amplification and readout by the ammeter 86.

It will be understood that in place of the positive collector plate 78, the potential may be applied between the burner nozzles 52, 54 and 56 and the negative collector plate 76 as was described above in connection with FIG. 1. Also, in lieu of the positive collector plate and the negative collector plate, cylindrical or ring type collector electrodes of the type described in FIG. i may be employed with good results.

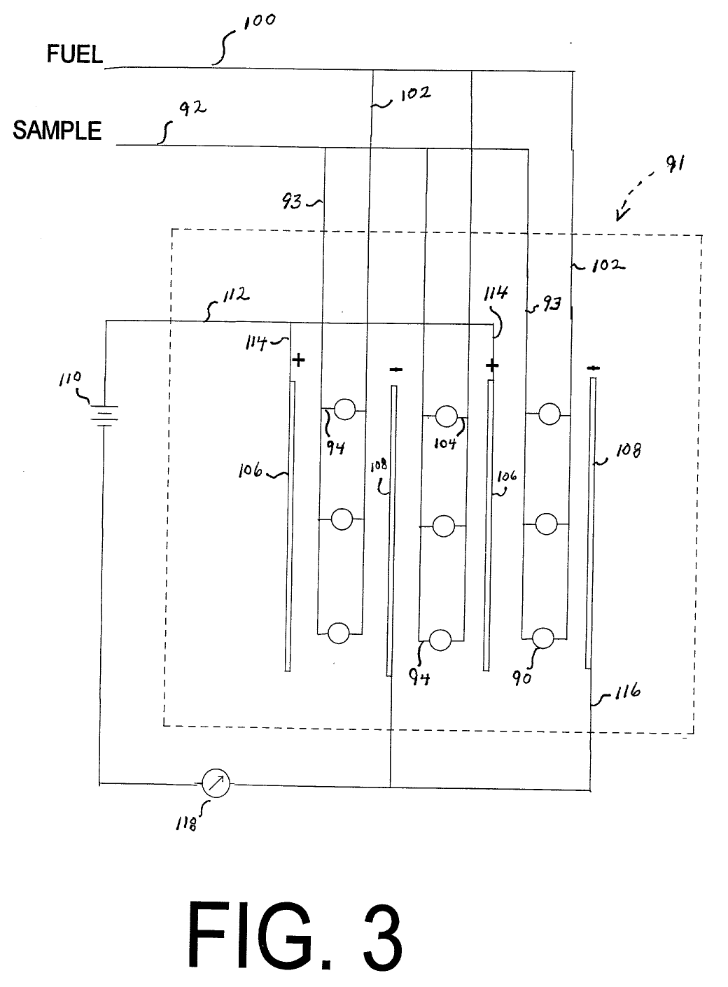

A nine burner nozzle combustion cell is schematically illustrated in FIG. 3. In this embodiment of the invention nine burner nozzles 90 are disposed in the housing 91 of the combustion cell and are preferably arranged in three rows of three burner nozzles each. Sample gas is introduced from a source of sample gas (not shown) by a line 92 and is distributed to each row of the burner nozzles by distribution lines 93. A capillary 94 communicates between each burner nozzle 90 and its corresponding distribution line 93. Similarly the fuel is distributed to the burner nozzles 90 through a line 100, distribution lines 102 and lines 104 communicating between the distribution lines and each burner nozzle. Positive collection electrodes 106 alternate with negative collection electrodes 108 for collection of the current created by the combustion and ionization of the sought for substance. Preferably the electrodes 106 and 108 are rectangularly shaped and the electrodes are disposed parallel to the other electrodes and to the rows of burner nozzles 90. Each row of burner nozzles 90 lies between a positive collection electrode 106 and a negative collection electrode 108. Potential is imposed across the collection electrodes 106 and 108 by a power supply, represented by a battery 110, through line 112, lines 114 and lines 116. These lines also conduct the current created by the ionization of the sought for substance to a suitable current amplification device (not shown) and an ammeter 118 for readout of the current produced. Operation of the nine burner nozzle combustion cell is the same as for the three burner combustion cell illustrated in FIG. 2 and described above.

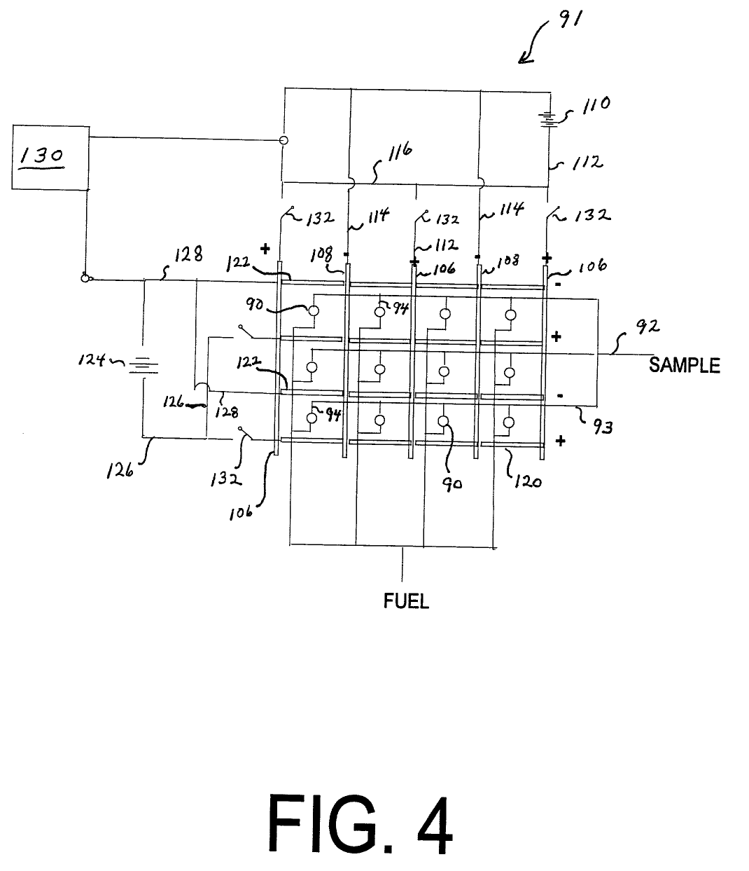

FIG. 4, wherein like reference numbers illustrate like parts and like functions, illustrates yet another embodiment of the invention in which the positive collection electrodes alternate with negative collection electrodes as in FIG. 3 and the collection electrodes extend in the housing 91 both laterally and transversely. As illustrated, twelve burner nozzles 90 are disposed in the housing 91 of combustion cell and are arranged in three rows of four burner nozzles each. Sample gas is introduced from a source of sample gas (not shown) by a line 92 and is distributed to each row of the burner nozzles 90 by distribution lines 93. A capillary 94 communicates between each burner nozzle 90 and its corresponding distribution line 93. Similarly the fuel is distributed to the burner nozzles 90 through a line 100, distribution lines 102 and lines 104 that communicate between the distribution lines and each burner nozzle. As in FIG. 3 the positive collection electrodes 106 alternate with the negative collection electrodes 108 that, for the purposes of description herein, are considered to extend in the housing 91 in a longitudinal direction. Extending perpendicularly to the collection electrodes 106 and 108 are positive collection electrodes 120 and negative collection electrodes 122. For the purposes of description herein collection electrodes 120 and 122 are defined as extending in a transverse direction in the combustion cell housing 91. As schematically illustrated, the collection electrodes 106 and 108 are electrically connected by the circuit represented by the battery 110 lines 112 lines 114 and 116. The collection electrodes 120 and 122 are electrically connected by a circuit schematically represented by a battery 124, a line 126 and lines 128. The output signals from both circuits are combined and conducted to a current amplifier and readout device 130. In this fashion each of the burners 90 is surrounded by a portion of the collection plates 120, 122, 106 and 108 to maximize detection of the output signal. It will be understood, however, that the positive collection electrodes 106 and 120 can be eliminated by making the burners the positive electrodes as described above. Switches 132 in the lines 112 and 126 permit selective removal of the output signals from one or more longitudinal and transverse rows of burners. In this fashion the strength of the output signal can be controlled without the necessity of adjusting the fuel or sample flow. It will be understood that while the invention is illustrated in FIG. 4 with two separate circuits it is well within the skill of the art to combine the collectors in a single circuit and to provide a switching device for each individual burner nozzle 90 so as to permit the switching on and off of the signal from individual burner nozzles.

From the foregoing it can be seen that the multi-burner combustion cell of the invention provides substantially improved sensitivity over the conventional single burner combustion cells. In addition the multi-burner combustion cell of the invention is stable and operates at reduced noise levels.

As will be understood by those skilled in the art, various arrangements which lie within the spirit and scope of the invention other than those described in detail in the specification will occur to those persons skilled in the art. It is therefor to be understood that the invention is to be limited only by the claims appended hereto.

Having described the invention, we claim:

1. A combustion cell for flame ionization detectors comprising:
a. a housing having an interior defining a combustion chamber, said combustion chamber being in communication with a source of an oxygen containing gas;
b. at least a pair of burner nozzles disposed in said combustion chamber; each said burner nozzle communicating with a common source of a sample gas;
c. a line communicating between each said burner nozzle and a source of fuel;
d. at least one collector being disposed in said combustion chamber, said collector consisting of polarized electrodes for the sensing of a electrical current created by the combustion and ionization of a sought for substance;
e. at least one ignition device disposed in said combustion chamber; and
f. electrical circuitry including a source of electrical power and current amplification and read out devices for imposing a potential across said electrodes of said collector and for read out of an electrical current sensed by said collector.

2. The combustion cell of claim 1 wherein said collector consists of a cylindrical electrode surrounding each said burner nozzle, each said burner nozzle being the other electrode of said collector, when said collector is activated an electrical potential is imposed between each said burner nozzle and a surrounding cylindrical electrode.

3. The combustion cell of claim 1 comprising three burner nozzles disposed in said combustion chamber.

4. The combustion cell of claim 1 comprising three rows of three burner nozzles disposed in said combustion chamber.

5. The combustion cell of claim 3 wherein said collector consists of a pair of electrodes having said burner nozzles disposed therebetween, said electrodes extending at least the length of said burner nozzle row.

6. The combustion cell of claim 4 wherein said collector consists of alternating positive and negative collection electrodes, each row of burner nozzles being disposed between a positive and a negative collection electrode.
